(19) United States
(12) Patent Application Publication
(10) Pub. No.: US 2004/0230703 A1
(43) Pub. Date: Nov. 18, 2004

(54) Network device, server device, client device, and method and program for assigning network IP address

(76) Inventor: Motoyuki Sukigara, Suginami-ku (JP)

Correspondence Address: McIntyre-Lilley Intellectual, Property Management Services, Suite #12, 2000 South 2nd Street, Arlington, VA, 22204, US

(21) Appl. No.: 10/152,317

(22) Filed: May 22, 2002

(30) Foreign Application Priority Data
Jun. 8, 2001 (JP) 2001-173599

(51) Int. Cl. G06F 15/16

(52) U.S. Cl. 709/253; 709/245

(57) ABSTRACT

A server device 10 and a client device 14 are connected with a network. The client device 14 detects an existence of the server device 10 based on an MAC address, and executes ping command while sequentially changing an IP address to search for a free IP address. The free IP address is automatically assigned as an IP address for the server device 10.

### TECHNICAL FIELD

The present invention relates generally to server devices connected to a network, and specifically relates to an automatic assignment of an IP address to a server device connected to a network.

### BACKGROUND OF THE INVENTION

The TCP/IP protocol has been used on networks, such as LANs (Local Area Networks), the Internet, and other distributed networks. Unique addresses (IP addresses) are assigned to individual devices on a TCP/IP network, and the IP addresses are used for identification.

However, the knowledge on the TCP/IP network is technical and it is not easy for general users to correctly assign the individual devices IP addresses.

Thus, though a DHCP (Dynamic Host Configuration Protocol) may be proposed for dynamically assigning individual clients, on a network, IP addresses on startup, there exists the complication of providing a DHCP server on the network.

### SUMMARY OF THE INVENTION

The present invention provides a device, a method, and a program for easily and surely building a network without a specific technical knowledge on networks or a DHCP server.

To achieve the above stated purpose, the present invention includes a network device comprising a server computer and a client computer connected with a communication line, wherein the server computer and the client computer use the TCP/IP protocol for communication, and the client computer includes a means for detecting the existence of the server computer, a means for detecting the existence of a DHCP server on the communication line, and a means for automatically assigning to the server computer an IP address when the server computer is detected. Conversely, when a DHCP server does not exist, an IP address is not assigned to the server computer.

It is preferable that the server computer includes neither a keyboard nor a display.

The means for detecting an existence of the server computer conducts the detection based on an MAC address of an NIC on the server computer.

It is preferable that the means for automatically assigning to the server computer an IP address comprises a means for detecting a free IP address based on the existence of a response data packet when a predetermined data packet is sent while changing a destination IP address, and a means for assigning any one of the free IP addresses as the IP address for the server computer.

The present invention includes a server device connected to a network comprising a means for entering a wait state until an IP address is assigned when a DHCP server does not exist on the network, and a means for storing an IP address as its own IP address sent from a client device other than the DHCP server on the network, and resetting the wait state.

It is preferable that the server device includes neither a keyboard nor a display.

The present invention includes a method for assigning to a server device connected with a TCP/IP network an IP address without a DHCP server comprising steps of detecting the existence of the server device connected with the network, detecting whether an IP address is assigned to the server device, and automatically assigning to the server device an IP address when an IP address is not assigned to the server device.

It is preferable that the step for detecting the existence of the server device detects an MAC address of an NIC on the server device in this method.

It is preferable that the automatically assigning to the server device an address comprises detecting free IP addresses based on the existence of a response data packet when a predetermined data packet is sent while changing a destination IP address, and assigning any one of the free IP addresses as an IP address for the server computer.

The present invention includes a computer program for assigning to a server device connected with a TCP/IP network an IP address without a DHCP server comprising detecting the existence of the server device connected with the network, detecting whether an IP address is assigned to the server device, and automatically assigning to the server device an IP address when an IP address is not assigned to the server device are executed.

The detection of a MAC address of an NIC on the server device is the means of detecting the existence of the server device in the program of the present invention.

It is preferable that automatically assigning to the server device an address comprises the detection of free IP addresses based on the existence of a response data packet when a predetermined data packet is sent while changing a destination IP address, and assigning any one of the free IP addresses as an IP address for the server computer.

In this way, an IP address is automatically assigned to a server device (a server computer) on a network without using a DHCP server. Specifically, a client device (a client computer) sends data on the network while changing a destination address, and detects free IP addresses based on whether a response exists. Namely, it is determined such that an IP address is in use when there is a response, and an IP address is free when there is no response. A ping command is an example of the type of command that may be used. Therefore, one of the free IP addresses is automatically assigned to the server device, and communication with the server device is enabled. Because an IP address is automatically assigned to the server device, a user simply has to connect the server device and the client device physically with the network, and thus can easily build a network.

In summary, a client device automatically assigns to the server device an address in accordance with the present invention, and a communication with the server device is enabled when the DHCP server does not exist. Therefore, an IP address is assigned without a DHCP server.

### BRIEF DESCRIPTION OF THE DRAWINGS

FIG. 1 illustrates a block diagram for a server device of an embodiment of the present invention.

FIG. 2 illustrates a front view and a rear view for a server device of an embodiment of the present invention.

FIG. 3 illustrates a network diagram of an embodiment of the present invention.

FIG. 4 illustrates a process flowchart for a client device of an embodiment of the present invention.

### DETAILED DESCRIPTION OF THE PREFERRED EMBODIMENTS

The following section describes a preferred embodiment of the present invention based on the above detailed drawings.

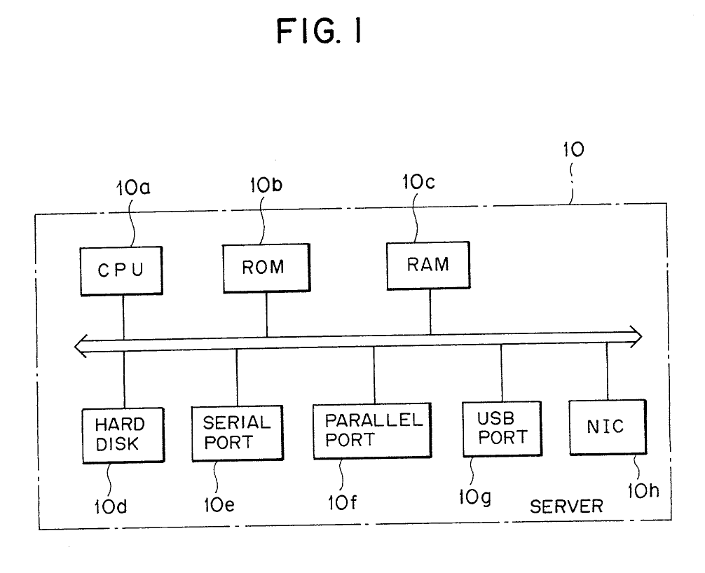

FIG. 1 shows a constitution block diagram of a server device (or a server computer) relating to the present embodiment.

The server device 10 comprises a CPU 10a, a ROM 10b where a BIOS program and the like are stored, a RAM 10c, a hard disk 10d, a serial port 10e, a parallel port 10f, a USB port 10g, and an NIC 10h. Though this is almost similar to a general computer, a specific point includes that there do not exist interfaces for a keyboard, a mouse, and video, and consequently there is no keyboard, mouse, or display is connected. Because there is no keyboard or display, a network administrator does not operate a keyboard to specify IP addresses and other settings as is the case for a conventional server device, and all settings are conducted through a client device (a client computer) connected with a network.

Linux, for example, is installed on the hard disk as an OS (Operating System) to start as a WWW server, and a CGI (Common Gateway Interface) is used for setting conditions from the client device.

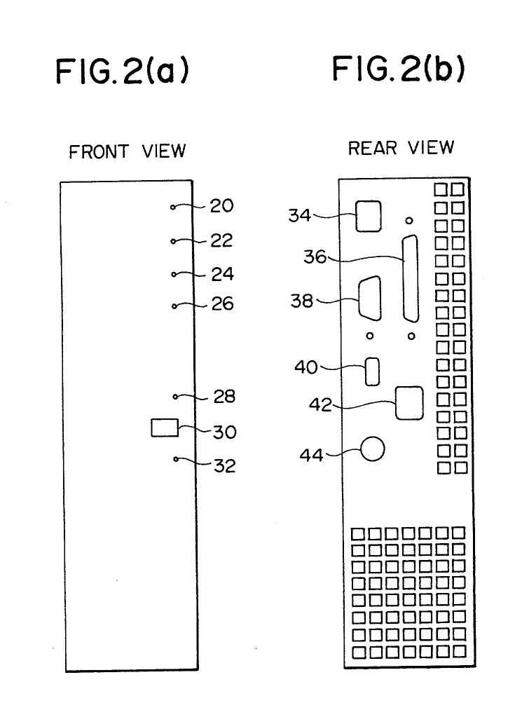

FIG. 2 shows an exterior of the server device 10 shown in FIG. 1. (a) is a front view and (b) is a rear view. A hard disk LED 20, a LAN LED 22, a status LED 24, an extended LAN LED 26, a power LED 28, a power switch 30, and a reset switch 32 are provided on a front face, and a LAN connector 34, a printer port 36, a serial port 38, a USB port 40, an extended LAN connector 42, and a power supply receptacle 44 are provided on a rear face. Connecting between the LAN connector 34 and a hub with a LAN cable (such as 10 BASE-T) physically establishes a connection with a network. Note that there is no port or connector for connecting with a keyboard, a mouse or a display as shown in the rear view.

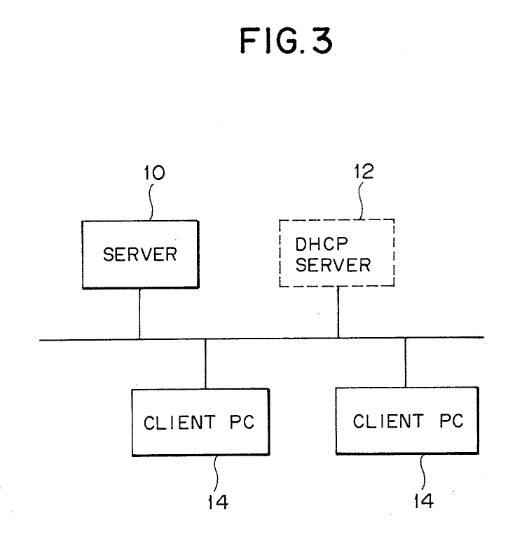

FIG. 3 shows a schematic network constitution of the present embodiment. The server device 10 and client devices (client PC's) 14 are connected with the same network. When the server device 10 and the client devices 14 are connected through a hub, they are connected using a so-called star type connection, needless to say. When the server device 10 and the client devices 14 use TCP/IP protocol to communicate with each other, it is necessary to assign IP addresses to identify the individual computers. When there exists a DHCP server 12 on the network, the DHCP 12 server usually assigns devices connected with the network IP addresses dynamically. Namely, a set of IP addresses are reserved on the DHCP server for the clients, IP addresses are sequentially assigned on a startup of the client device, and the assigned IP address is recovered upon the shutdown of the client device.

When the DHCP server 12 does not exist on the network, a network administrator, who has specialized knowledge, has to manually assign to the individual devices IP addresses, and it is relatively difficult to correctly assign IP addresses without redundancy.

Even when the DHCP server 12 does not exist on the network, the client device 14 is used to simply assign to the server device 10 an IP address automatically in the present embodiment.

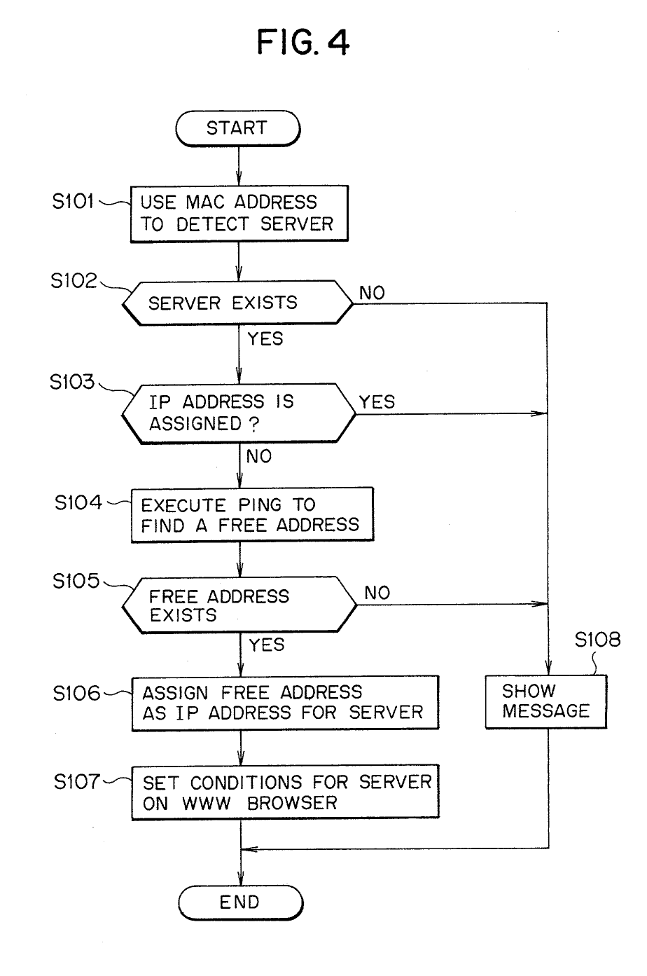

FIG. 4 shows a process flowchart when the CPU in client device 14 executes an installed program, while both the server device 10 and the client device 14 are connected with the network. This program can be installed on a hard disk in the client device 14 from a recording medium, such as a FD and a CD-ROM.

First, the client device 14 uses an MAC (Media Access Control) address assigned to an NIC (Network Interface Card) 10h in the server device 10 to determine whether the server device 10 exists on the network (S101). When a MAC address comprises six bytes, the upper three bytes identify a NIC manufacturer, and the lower three bytes identify a product number which the manufacturer assigned.

When the server device 10 is detected, namely there exists a device including a predetermined MAC address, the client device 14 determines whether an IP address has already been assigned to the server device 10 (S102). When the server device 10 starts while it is connected with the network, and if a DHCP server 12 exits, it has an IP address assigned by the DHCP server 12, and if a DHCP server 12 does not exist, an action of the OS installed on the hard disk enters it in a wait state for receiving an IP address from an external source.

Thus, when the DHCP server 12 does not exist, it is determined that an IP address is not assigned to the server device 10. In this case, the client device 14 executes a ping command to search for free addresses (S104). The ping command is a command for checking a network connection, when the command is executed while an IP address of a destination device for which a connection is checked is specified, a packet for the check is sent to a specified destination. A receiving end receives the packet, and sends a reply packet to a sending end, and a connection is checked. The client device 14 executes the ping command while sequentially changing an IP address as “192.168.10.10”, “192.168.10.11”, “192.168.10.12”, . . . , checks for a replay, and determines that if there is a reply, an IP address is already used by other device on the network, and if there is no reply, it is a free IP address which is not in use in a process in S104.

When it is determined that there is a free address as a result of the ping command (S105), the client device 14 assigns the IP address “XXX.XXX.XXX.XXX” as a private IP address for the server device 10 (S106). It is preferable that a display of the client device 14 shows a user that the server device 10 is detected on the network, and “XXX.XXX.XXX.XXX” is assigned as an IP address at this time. This allows the user to know that the IP address is automatically assigned to the server device 10, and communication is available.

On the other hand, if the server device 10 is not detected, an IP address is assigned to the server device 10, or no free address is available in S102, a message for telling the situation is shown on the display of client device 14 (S108). For example, if the server device 10 is not detected, a message “Server device was not detected. Check connection.” is shown. When an IP address is automatically assigned to the server device 10 in S104 to S106, the display of client device 14 may show a message for telling of this situation. For example, the message “Because network investigation did not detect DHCP server, this software assigns IP address to server device” is shown.

After the IP is automatically assigned to the server device 10, as described above, a WWW browser starts on the client device 14, the assigned IP address is converted into a URL, and a CGI for setting items for the server device 10 starts. The user enters a computer name, a domain name, and an access right for the server device 10 on the WWW browser (S107). It is possible to make the IP address assigned in S106 as a temporary IP address for a specified period, and to set a new IP address and subnet mask to the server device 10 on the WWW browser.

While a case where a LAN cable is used to connect with a network is exemplified as the embodiment of the present invention, the embodiment can also apply to a case where a wireless LAN card or a wireless LAN adaptor is used to connect with a network in a similar way.

While it is assumed that an IP address is not statically assigned to the server device 10 on a start up of the OS in the present embodiment, a switch may be provided on the server device 10, and the user may accordingly select a case where a static IP address is used, or a case where a client device is used to dynamically assign an IP address as in the present embodiment.

While the program on the client device 14 uses the ping command to detect a free IP address in the present embodiment, the method for detecting a free IP address is not limited to this case. For example, it is possible to try to connect with a TCP port 137, and to detect an existence of a destination, and further the usage of an IP address based on the existence of a “Destination-unreachable” packet sent from a destination. Namely, an arbitrary command other than the ping command that is used to detect a free IP address.

Those skilled in the art will recognize that the method and apparatus of the present invention has many applications, and that the present invention is not limited to the representative examples disclosed herein. Although illustrative, the embodiments disclosed herein have a wide range of modification, change and substitution that is intended and in some instances some features of the present invention may be employed without a corresponding use of the other features.

Moreover, the scope of the present invention covers conventionally known variations and modifications to the system components described herein, as would be known by those skilled in the art. Accordingly, it is appropriate that the appended claims be construed broadly and in a manner consistent with the scope of the invention.

What is claimed is:

1. A network device comprising:
a server computer with a communication line; and
a client computer connected with said communication line,
wherein said server computer and said client computer use TCP/IP protocol for communication, and said client computer includes a means for detecting an existence of said server computer, a means for detecting an existence of a DHCP server on the communication line, and a means for automatically assigning to said server computer an IP address when said server computer is detected and when said DHCP server does not exist, and when said server computer is not assigned an IP address.

2. The network device according to claim 1, wherein said server computer includes neither a keyboard nor a display.

3. The network device according to claim 1, wherein said means for detecting the existence of said server computer conducts the detection based on a MAC address of a NIC on said server computer.

4. The network device according to claim 1, wherein said means for automatically assigning to said server computer an IP address further comprises:
a means for detecting a free IP address based on an existence of a response data packet when a predetermined data packet is sent while changing a destination IP address; and
a means for assigning any one of said free IP addresses as an IP address for said server computer.

5. A server device connected with a network comprising:
a means for entering a wait state until an IP address is assigned when a DHCP server does not exist on said network, and
a means for storing an IP address as its own IP address sent from a client device other than said DHCP server on said network address.

5(a). The server device according to claim 5, further comprising:
a means for resetting said wait state.

6. The server device according to claim 5, wherein said server device includes neither a keyboard nor a display.

7. A method for assigning a server device connected to a TCP/IP network an IP address without a DHCP server comprising:
detecting the existence of said server device connected to said network;
detecting whether an IP address is assigned to said server device; and
automatically assigning to said server device an IP address when an IP address is not assigned to said server device.

8. The method according to claim 7, wherein said step for detecting the existence of said server device detects the MAC address of a NIC on said server device.

9. The method according to claim 7, wherein said automatically assigning said server device an address further comprises:
detecting free IP addresses based on the existence of a response data packet when a predetermined data packet is sent, while changing a destination IP address; and
assigning any one of said free IP addresses as an IP address for said server computer.

10. A computer program for assigning a server device connected with a TCP/IP network an IP address without a DHCP server comprising:
detecting the existence of said server device connected to said network;
detecting whether an IP address is assigned to said server device; and
automatically assigning to said server device an IP address when an IP address is not assigned to said server device.

11. The program according to claim 10, wherein detecting a MAC address of a NIC on said server device detects the existence of said server device.

12. The program according to claim 10, wherein said automatically assigning said server device an address further comprises:
detecting free IP addresses based on the existence of a response data packet when a predetermined data packet is sent while changing a destination IP address; and
assigning any one of said free IP addresses as an IP address for said server computer.
